(19) United States
(12) Patent Application Publication
(10) Pub. No.: US 2014/0202696 A1
(43) Pub. Date: Jul. 24, 2014

(54) INTERPENETRATING POLYMER NETWORK DEFORMABLE PROPPANT

(71) Applicants: Liang Hong, Midland, MI (US); Aaron Johnson, Freeland, MI (US); Marvin Tegen, Midland, MI (US); Ari Kar, Midland, MI (US); Timothy Dellinger, Midland, MI (US)

(72) Inventors: Liang Hong, Midland, MI (US); Aaron Johnson, Freeland, MI (US); Marvin Tegen, Midland, MI (US); Ari Kar, Midland, MI (US); Timothy Dellinger, Midland, MI (US)

(73) Assignee: Dow Global Technologies LLC, Midland, MI (US)

(21) Appl. No.: 14/238,490

(22) PCT Filed: Aug. 10, 2012
(86) PCT No.: PCT/US2012/050311

§ 371 Date: Feb. 12, 2014

Related U.S. Application Data
(60) Provisional application No. 61/522,860, filed on Aug. 12, 2011.

(51) Int. Cl. C09K 8/80; E21B 43/267

(52) U.S. Cl. CPC C09K 8/80; E21B 43/267
USPC 166/280.2; 507/231

(57) ABSTRACT

Embodiments of the present disclosure include a method for treating a subterranean formation including injecting into the subterranean formation a fluid composition that includes a fluid and a deformable proppant having an interpenetrating polymer network formed from a first polymer component and a second polymer component.

### FIELD OF DISCLOSURE

Embodiments of the present disclosure are directed towards deformable proppants; more specifically, embodiments are directed toward methods of treating a subterranean formation with the deformable proppants and processes for obtaining the deformable proppants.

### BACKGROUND

Subterranean formations can include recoverable fluids such as oil, gas, and/or water. For some subterranean formations there may not be sufficient porosity and/or permeability to allow the recoverable fluids to flow within the subterranean formation to a recovery wellbore at sufficient rates. In addition, the flow of recoverable fluids may be diminished over time.

To address these issues a process called “fracturing”, e.g. hydraulic fracturing, can be used to enhance and/or maintain production of recoverable fluids from a subterranean formation. Fracturing can include injecting a fracturing fluid, sometimes referred to as a carrier fluid, into the subterranean formation at a pressure that is sufficiently high enough to cause fractures to form and/or enlarge in the subterranean formation.

To help maintain these fractures, a proppant may be injected into the subterranean formation, for example via the fracturing fluid. The proppant may be deposited upon a surface of the subterranean formation and serve to hold the fracture open, thereby enhancing the ability of a recoverable fluid to flow to the recovery wellbore via the fracture.

### SUMMARY

One or more embodiments of the present disclosure include a method for treating a subterranean formation, where the method includes injecting into the subterranean formation a fluid composition that includes a fluid and a deformable proppant having an interpenetrating polymer network that includes a first polymer component and a second polymer component.

One or more embodiments of the present disclosure also include a deformable proppant useful for treatment of a subterranean formation, where the deformable proppant is obtainable by a process that includes forming a first polymer component from a first monoethylenically unsaturated monomer and a first polyethylenically unsaturated monomer, forming a suspension of the first polymer component in a continuous aqueous phase, where the first polymer component is particulate, and forming a second polymer component from a second monoethylenically unsaturated monomer and a second polyethylenically unsaturated monomer, where the first polymer component and the second polymer component form an interpenetrating polymer network.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### DETAILED DESCRIPTION

Embodiments of the present disclosure provide methods for treating a subterranean formation. The methods for treating the subterranean formation include injecting into the subterranean formation a fluid composition that includes a fluid and a deformable proppant having an interpenetrating polymer network formed from a first polymer component and a second polymer component.

Embodiments of the present disclosure provide the deformable proppant having the interpenetrating polymer network formed from the first polymer component and the second polymer component. It has been found that deformable proppants having the interpenetrating polymer network formed from the first polymer component and the second polymer component can provide a gap width and/or conductivity comparable to or greater than other proppants that do not include the interpenetrating polymer network. Surprisingly, the deformable proppants having the interpenetrating polymer network can provide the gap width and/or conductivity comparable to or greater than other proppants that do not include the interpenetrating polymer network even when those other proppants include a greater weight percentage of crosslinker.

A fractured subterranean formation's productivity can depend on the ability of the fracture to conduct a recoverable fluid from the subterranean formation to a recovery wellbore. As such, conductivity can be an important parameter for treating a subterranean formation. Conductivity in a subterranean formation can be influenced by the dimensions of a fracture. For example, a fracture having a greater gap width compared to another fracture having a lesser gap width may have a greater conductivity. As mentioned, the deformable proppants of the present disclosure can provide an improved gap width and/or an improved conductivity compared to other proppants. However, it surprisingly found that the deformable proppants of the present disclosure can provide an improved gap width and/or an improved conductivity even when the deformable proppants of the present disclosure have a lesser relative average particle size than other proppants having a greater relative average particle size.

While providing the improved gap width and/or conductivity, the deformable proppants of the present disclosure may yield to some degree, e.g. deform, upon application of a point to point force, such as compression between two faces of a fracture. For example, the deformable proppants of the present disclosure may deform in a width dimension (x-axis), a length dimension (y-axis), and/or a height dimension (z-axis) when subjected to a unilateral compressive force, e.g. along the z-axis. This deformability can help provide that the deformable proppants of the present disclosure do not shatter under a closure pressure applied by a fracture. This deformability can help provide an increased surface to oppose the closure pressure and/or reduce penetration of the deformable proppants into a surface of the fracture, thus helping to provide a greater fracture width and correspondingly greater conductivity as compared to other proppants. This deformability can also help reduce potential embedment of proppants into a surface of a subterranean formation, thus providing a greater gap width and greater conductivity compared to other proppants. Further, this deformability can also help reduce damage to a subterranean formation, e.g. spalling, thus helping to prevent generation of fragments from surrounding rocks in the subterranean formation and providing a greater conductivity compared to other proppants. Under some fracture conditions, e.g. a particular closure pressure and/or temperature, other proppants may partially and/or completely fail, e.g. shatter. The partial and/or complete failure may result in the generation of fines, which are smaller pieces of a proppant that are separated from the proppant. Generation of these fines can result in a lesser fracture width and correspondingly lesser conductivity because the fines reduce the proppant opposing the closure pressure of the fracture. Additionally, generation of these fines can lead to a reduced conductivity because the fines may agglomerate to decrease permeability of the fracture.

The deformable proppants of the present disclosure are suitable for use in a variety of fracture conditions. The deformable proppants of the present disclosure may be employed in a fracture having a temperature in a range of 0 degrees Celsius (° C.) to 300° C. All individual values and subranges from 0° C. to 300° C. are included herein and disclosed herein; for example, the deformable proppants of the present disclosure may be employed in a fracture having a temperature in a range having a lower limit of 0 degrees ° C., 5° C., 10° C., or 15° C. to an upper limit of 300° C., 290° C., 280° C., or 260° C. For example, the deformable proppants may be employed in a fracture having a temperature in a range of 0° C. to 300° C., 5° C. to 290° C., 10° C. to 280° C., or 15° C. to 260° C.

The deformable proppants of the present disclosure may be employed in a fracture having a closure force in a range of 5 megapascal (MPa) to 100 MPa. All individual values and subranges from 5 MPa to 100 MPa are included herein and disclosed herein; for example, the deformable proppants of the present disclosure may be employed in a fracture having a closure force in a range having a lower limit of 5 MPa, 7 MPa, 9 MPa, or 10 MPa to an upper limit of 100 MPa, 98 MPa, 95 MPa, or 90 MPa. For example, the deformable proppants may be employed in a fracture having a closure force in a range of 5 MPa to 100 MPa, 7 MPa to 98 MPa, 9 MPa to 95 MPa, or 10 MPa to 90 MPa.

For one or more embodiments, the deformable proppants of the present disclosure provide a conductivity in the subterranean formation of at least 100 millidarcy-feet at 38 degrees Celsius. Temperature may affect the conductivity that a proppant can provide. For example, as temperature increases a proppant may soften and allow the proppant to become more compressible than the proppant would be at a lower temperature. This relative greater compressibility can diminish the proppant's ability to maintain a gap width, thus reducing conductivity. For one or more embodiments, the deformable proppants of the present disclosure may provide a greater gap width and/or greater conductivity at a first temperature having a value lower than a second temperature.

As discussed, the methods for treating the subterranean formation of the present disclosure may include injecting into the subterranean formation a fluid composition that includes a fluid and the deformable proppant. The fluid may be injected into the subterranean formation at differing rates for various applications and/or differing subterranean formations. An injection rate for various applications may be determined with various software including, but not limited to, Mfrac™, FracPro® PT, StimPlan™, FracCADE®, and GOHFER®. For one or more embodiments, the rate may be sufficient to increase a pressure in the subterranean formation such that a fracture is formed in the subterranean formation. However, a fracture in a subterranean formation may be formed by other means, which include, but are not limited to, another hydraulic pressure application, acid fracturing, hydro jetting, or combinations thereof.

For one or more embodiments, the fluid may be selected from the group of water-based fluids, hydrocarbon-based fluids, foams, gas-based fluids and combinations thereof. For some applications, the fluid may be selected based at least in part upon a density of the deformable proppant so that desirable proppant transfer rates and/or proppant deposit upon a surface of the subterranean formation are realized.

Water-based fluids may be from 100.0 weight percent water to 50.0 weight percent water. All individual values and subranges from 100.0 weight percent water to 50.0 weight percent water are included herein and disclosed herein; for example, water-based fluids may be from an upper limit of 100.0 weight percent water, 99.5 weight percent water, 99.0 weight percent water, 98.5 weight percent water, or 98.0 weight percent water to a lower limit of 50 weight percent water, 60.0 weight percent water, 70.0 weight percent water, 80.0 weight percent water, or 90.0 weight percent water, where the weight percents are based upon a total weight of the water-based fluid. For example, water-based fluids may be from 100.0 weight percent water to 50.0 weight percent water, from 99.5 weight percent water to 60.0 weight percent water, from 99.0 weight percent water to 70.0 weight percent water, from 98.5 weight percent water to 80.0 weight percent water, or from 98.0 weight percent water to 90.0 weight percent water, where the weight percents are based upon a total weight of the water-based fluid.

Hydrocarbon-based fluids may be from 100 weight percent hydrocarbon to 25 weight percent hydrocarbon. All individual values and subranges from 100 weight percent hydrocarbon to 25 weight percent hydrocarbon are included herein and disclosed herein; for example, hydrocarbon-based fluids may be from an upper limit of 100 weight percent hydrocarbon, 99 weight percent hydrocarbon, 95 weight percent hydrocarbon, 90 weight percent hydrocarbon, or 85 weight percent hydrocarbon to a lower limit of 25 weight percent hydrocarbon, 30 weight percent hydrocarbon, 35 weight percent hydrocarbon, 40 weight percent hydrocarbon, or 45 weight percent hydrocarbon, where the weight percents are based upon a total weight of the hydrocarbon-based fluid. For example, hydrocarbon-based fluids may be from 100 weight percent hydrocarbon to 25 weight percent hydrocarbon, from 99 weight percent hydrocarbon to 30 weight percent hydrocarbon, from 95 weight percent hydrocarbon to 35 weight percent hydrocarbon, from 85 weight percent hydrocarbon 90 weight percent hydrocarbon to 40 weight percent hydrocarbon, or from to 45 weight percent hydrocarbon, where the weight percents are based upon a total weight of the hydrocarbon-based fluid. The hydrocarbon-based fluid may include one or more different hydrocarbons for various applications and/or differing subterranean formations.

The foam may be a dispersion in which a gas is dispersed in a liquid, or a gelled fluid. For one or more embodiments, the foam may include a gas phase and a liquid phase. Examples of the gas include, but are not limited to, nitrogen, carbon dioxide, air, and combinations thereof. The foam may include one or more different gasses and/or one or more different liquids for various applications and/or differing subterranean formations.

For one or more embodiments, the fluid may be a gelled fluid. The gelled fluid may include a linear gel, a crosslinked gel, and combinations thereof. A linear gelled fluid may include guar gum, guar derivaties, cellulose derivatives, and combinations thereof. Examples guar derivaties and cellulose derivatives include, but are not limited to, hydroxypropylguar, carboxymethylhydroxypropylguar, carboxymethylguar, hydroxyethylecellulose, and combinations thereof. A crosslinked gelled fluid may be formed with a metal ion, such as, but not limited to, a chromium ion, an aluminum ion, a titanium ion, and combinations thereof.

Gas-based fluids may be from 100 weight percent gas to 25 weight percent gas. All individual values and subranges from 100 weight percent gas to 25 weight percent gas are included herein and disclosed herein; for example, gas-based fluids may be from an upper limit of 100 weight percent gas, 99 weight percent gas, 95 weight percent gas, 90 weight percent gas, or 85 weight percent gas to a lower limit of 25 weight percent gas, 30 weight percent gas, 35 weight percent gas, 40 weight percent gas, or 45 weight percent gas, where the weight percents are based upon a total weight of the gas-based fluid. For example, gas-based fluids may be from 100 weight percent gas to 25 weight percent gas, from 99 weight percent gas to 30 weight percent gas, from 95 weight percent gas to 35 weight percent gas, from 85 weight percent gas 90 weight percent gas to 40 weight percent gas, or from to 45 weight percent gas, where the weight percents are based upon a total weight of the gas-based fluid. The gas-based fluid may include one or more different gasses for various applications and/or differing subterranean formations. Examples of the gas include, but are not limited to, nitrogen, methane, and combinations thereof.

As discussed, the methods for treating the subterranean formation of the present disclosure may include injecting into the subterranean formation a fluid composition that includes the fluid and the deformable proppant. The deformable proppant may be included in the fluid composition at various concentrations for differing applications, which may be determined with various software including, but not limited to, Mfrac™, FracPro® PT, StimPlan™, FracCADE®, and GOHFER®.

The deformable proppant may be included in the fluid composition at differing concentrations for various applications and/or differing subterranean formations. For example, in a full proppant monolayer application proppant particles may be tightly packed together to form the full proppant monolayer on a surface of the subterranean formation. However, in a partial proppant monolayer application there can be vacant spaces around and/or between proppant particles on a surface of the subterranean formation.

For one or more embodiments, the deformable proppant may be employed at a concentration that creates a partial proppant monolayer on a surface of the subterranean formation. The partial proppant monolayer can help provide that a recoverable fluid flows in the vacant spaces of the partial proppant monolayer to a recovery wellbore. For one or more embodiments, the deformable proppants that create the partial proppant monolayer on the surface of the subterranean formation may cover 10 percent or more of the surface. The deformable proppants that create the partial proppant monolayer on the surface of the subterranean formation may cover from 10 percent to 90 percent of the surface of the subterranean formation. All individual values and subranges from 10 percent to 90 percent of the surface of the subterranean formation are included herein and disclosed herein; for example, the deformable proppants that create the partial proppant monolayer on the surface of the subterranean formation may cover a percent of the surface of the subterranean formation in a range having a lower limit of 10 percent, 20 percent, or 30 percent to an upper limit of 80 percent, 85 percent, or 90 percent of the surface of the subterranean formation. For example, the deformable proppants may cover from 10 percent to 90 percent, 20 percent to 85 percent, or 30 percent to 80 percent of the surface of the subterranean formation.

For one or more embodiments, the fluid composition may include one or more additives. Examples of such additives include, but are not limited to, hydrate inhibitors, clay stabilizers, sulfide scavengers, fibers, nanoparticles, consolidating agents (such as resins and/or tackifiers), salts, salt substitutes (such as tetramethyl ammonium chloride), soaps, surfactants, co-surfactants, additional crosslinkers, carboxylic acids, acids, fluid loss control additives, buffers, foamers, defoamers, emulsifiers, demulsifiers, iron control agents, solvents, mutual solvents, particulate diverters, biopolymers, synthetic polymers, corrosion inhibitors, corrosion inhibitor intensifiers, pH control additives, scale inhibitors, asphaltene inhibitors, paraffin inhibitors, catalysts, stabilizers, chelants, clay control agents, biocides, bactericides, friction reducers, antifoam agents, bridging agents, dispersants, flocculants, H₂S scavengers, CO₂ scavengers, oxygen scavengers, lubricants, viscosifiers, breakers, breaker activators, weighting agents, relative permeability modifiers, surface modifying agents, resins, wetting agents, coating enhancement agents, and combinations thereof. The fluid composition may include one or more different additives for various applications and/or differing subterranean formations. A concentration for the one or more additives in the fluid composition may have differing values for various applications and/or differing subterranean formations.

The deformable proppants of the present disclosure may be obtained by a batch process, a continuous process, and combinations thereof. Structures having the interpenetrating polymer network formed from the first polymer component are discussed in U.S. Pat. No. 4,646,644, which is incorporated herein by reference in its entirety. Additionally, structures having the interpenetrating polymer network formed from the first polymer component may be viewed as having a gradient of polymer structure along a radius of the structure. These structures are discussed in U.S. Pat. No. 5,068,255, which is incorporated herein by reference in its entirety.

For one or more embodiments, the deformable proppants of the present disclosure are obtainable by forming a first polymer component from a first monoethylenically unsaturated monomer and a first polyethylenically unsaturated monomer. Herein, a polyethylenically unsaturated monomer may be referred to as a crosslinker. The first polymer component may be formed by a suspension polymerization of the first monoethylenically unsaturated monomer and the first polyethylenically unsaturated monomer. The suspension polymerization may be a free radical process that includes mechanical agitation to disperse the first monoethylenically unsaturated monomer and the first polyethylenically unsaturated monomer in a continuous aqueous phase, such as water. For one or more embodiments, the first polymer component may be referred to as a seed particle.

For one or more embodiments, the first monoethylenically unsaturated monomer is a monovinylidiene aromatic. Examples of monovinylidiene aromatics include, but are not limited to, styrene, vinyl naphthalene, alkyl substituted styrenes, halo-substituted styrenes, and combinations thereof. Examples of alkyl substituted styrenes include, but are not limited to, vinyltoluene, ethyl vinylbenzene, and combinations thereof. Examples of halo-substituted styrenes include, but are not limited to, bromo-styrene, chloro-styrene, and combinations thereof.

For one or more embodiments, the first polyethylenically unsaturated monomer is a polydivinylidene aromatic. Examples of polydivinylidene aromatics include, but are not limited to, divinylbenzene, divinyltoluene, divinylxylene, divinylnaphthalene, trivinylbenzene, divinyl diphenyl ether, divinyl diphenyl sulfone, esters of α,β-ethylenically unsaturated carboxylic acids, and combinations thereof. Examples of esters of α,β-ethylenically unsaturated carboxylic acids include, but are not limited to, methyl methacrylate, ethyl acrylate, alkylene diacrylates, alkylene dimethacrylates, and combinations thereof. Examples of the first monoethylenically unsaturated monomer and the first polyethylenically unsaturated monomer may be found at Polymer Processes, edited by Calvin E. Schidknecht, published in 1956 by Interscience Publishers, Inc., New York, Chapter III, “Polymerization in Suspension” by E. Trommsdoff and C. E. Schidknecht, pp. 69-109, incorporate herein by reference.

The first polymer component may be prepared using from 0.1 weight percent to 10.0 weight percent of the first polyethylenically unsaturated monomer, where the weight percents are based upon a total weight of the constitutional units of the first polymer component. As used herein, “constitutional unit” refers to an atom or group of atoms, with pendant atoms or groups, if any, forming a structural part of the first polymer component and/or the second polymer component of the interpenetrating polymer network. All individual values and subranges from 0.1 weight percent to 10.0 weight percent of the first polyethylenically unsaturated monomer are included herein and disclosed herein; for example, the first polymer component may be prepared using from 0.1 weight percent to 8.0 weight percent of the first polyethylenically unsaturated monomer, or 0.1 weight percent to 5.0 weight percent of the first polyethylenically unsaturated monomer, where the weight percents are based upon a total weight of the constitutional units of the first polymer component.

The first polymer component may be prepared using from 99.9 weight percent to 90.0 weight percent of the first monoethylenically unsaturated monomer, where the weight percents are based upon a total weight of the constitutional units of the first polymer component. All individual values and subranges from 99.9 weight percent to 90.0 weight percent of the first monoethylenically unsaturated monomer are included herein and disclosed herein; for example, the first polymer component may be prepared using from 99.9 weight percent to 92.0 weight percent of the first monoethylenically unsaturated monomer, or 99.9 weight percent to 95.0 weight percent of the first monoethylenically unsaturated, where the weight percents are based upon a total weight of the constitutional units of the first polymer component.

The suspension polymerization that may be employed to form the first polymer component can include one or more compounds in addition to the first monoethylenically unsaturated monomer and the first polyethylenically unsaturated monomer. Examples of these compounds include, but are not limited to, suspending agents, polymerization inhibitors, free-radical initiators, surfactants, and combinations thereof.

Examples of a suspending agent include, but are not limited to, carboxy methyl methyl cellulose and products available under the trade name Walocel™ . The suspending agent may be employed in various amounts for differing applications.

An example of a polymerization inhibitor includes, but is not limited to, sodium dichromate. The polymerization inhibitor may be employed in various amounts for differing applications.

Examples of free radical initiators include, but are not limited to, tert-butyl peroctoate and tert-butyl perbenzoate. The free radical initiator may be employed in a range of from 0.05 weight percent to 4.00 weight percent based on a total weight of the first monoethylenically unsaturated monomer and the first polyethylenically unsaturated monomer. All individual values and subranges from 0.05 weight percent to 4.00 weight percent are included herein and disclosed herein; for example, free radical initiator may be employed in a range of from 0.55 weight percent to 3.50 weight percent, 0.06 weight percent to 3.00 weight percent, or 0.65 weight percent to 3.00 weight percent based on a total weight of the first monoethylenically unsaturated monomer and the first polyethylenically unsaturated monomer.

An example of a surfactant includes, but is not limited to, sodium lauryl sulfate. The surfactant may be employed in various amounts for differing applications.

The suspension polymerization that may be employed to form the first polymer component can be maintained at a temperature in a range from 20° C. to 140° C. All individual values and subranges from 20° C. to 140° C. are included herein and disclosed herein; for example, the suspension polymerization that may be employed to form the first polymer component can be maintained at a temperature in a range having a lower limit of 20° C., 23° C., or 25° C. to an upper limit of 140° C., 130° C., or 120° C. For example, the suspension polymerization can be maintained at a temperature in a range from 20° C. to 140° C., 23° C. to 130° C., or 25° C. to 120° C.

The suspension polymerization that may be employed to form the first polymer component can be maintained at a temperature for a time interval in a range of 10 minutes to 24 hours. All individual values and subranges from in a range of 10 minutes to 24 hours are included herein and disclosed herein; for example, the suspension polymerization that may be employed to form the first polymer component can be maintained at a temperature for a time interval a with a lower limit of 10 minutes, 15 minutes, or 30 minutes to an upper limit of 24 hours, 18 hours, or 10 hours. For example, suspension polymerization can be maintained at a temperature for a time interval in a range of 10 minutes to 24 hours, 15 minutes to 18 hours, or 30 minutes to 10 hours. The suspension polymerization that may be employed to form the first polymer component can be maintained at differing temperatures, where each of the differing temperatures is maintained for a particular time interval.

For one or more embodiments, obtaining the deformable proppant includes forming a suspension the first polymer component in a continuous aqueous phase, where the first polymer is particulate. As used herein, “particulate” refers to being separate and distinct particles. This suspension may be in a continuous aqueous phase, such as water, and may include mechanical agitation.

The second polymer component may be formed by a suspension polymerization of a second monoethylenically unsaturated monomer and a second polyethylenically unsaturated monomer. The suspension polymerization that may be employed to form the second polymer component can include the plurality polymer particles including the first polymer component, the second monoethylenically unsaturated monomer, and the second polyethylenically unsaturated monomer, where the monomers are polymerized to form the second polymer component. The suspension polymerization that may be employed to form the second polymer component can include one or more compounds, as discussed herein, in addition to the second monoethylenically unsaturated monomer and the second polyethylenically unsaturated monomer. Examples of these compounds include, but are not limited to, suspending agents, polymerization inhibitors, free-radical initiators, surfactants, and combinations thereof. For the suspension polymerization that may employed to form the second polymer component these compounds may be included based upon a total weight of the second monoethylenically unsaturated monomer and the second polyethylenically unsaturated monomer.

For one or more embodiments, the first polymer component, where the first polymer component is particulate, may imbibe the second monoethylenically unsaturated monomer, the second polyethylenically unsaturated monomer, and optionally one or more of the compounds, as discussed herein. This imbibing and/or the suspension polymerization that may be employed to form the second polymer component can be referred to as swelling, e.g. swelling the plurality polymer particles including the first polymer component, or swelling the first polymer component. The suspension polymerization that may be employed to form the second polymer component may form the interpenetrating polymer network from the first polymer component and the second polymer component. For one or more embodiments, the interpenetrating polymer network includes the first polymer component and the second polymer component, where the first polymer component and the second polymer component are at least partially interlaced on a molecular scale but not covalently bonded to each other and cannot be separated unless chemical bonds are broken due to their entanglement.

The second monoethylenically unsaturated monomer may include the monoethylenically unsaturated monomers, as discussed herein. The second polyethylenically unsaturated monomer may include the polyethylenically unsaturated monomers, as discussed herein.

The second polymer component may be prepared using from 0.5 weight percent to 20.0 weight percent of the second polyethylenically unsaturated monomer, where the weight percents are based upon a total weight of the constitutional units of the second polymer component. All individual values and subranges from 0.5 weight percent to 20.0 weight percent are included herein and disclosed herein; for example, the second polymer component may be prepared using from 0.5 weight percent to 15.0 weight percent of the second polyethylenically unsaturated monomer, or 0.5 weight percent to 10.0 weight percent of the second polyethylenically unsaturated monomer, where the weight percents are based upon a total weight of the constitutional units of the second polymer component.

The second polymer component may be prepared using from 99.5 weight percent to 80.0 weight percent of the second monoethylenically unsaturated monomer, where the weight percents are based upon a total weight of the constitutional units of the second polymer component. All individual values and subranges from 99.5 weight percent to 80.0 weight percent are included herein and disclosed herein; for example, the second polymer component may be prepared using from 99.5 weight percent to 85.0 weight percent of the second monoethylenically unsaturated monomer, or 99.5 weight percent to 90.0 weight percent of the second monoethylenically unsaturated monomer, where the weight percents are based upon a total weight of the constitutional units of the second polymer component. For one or more embodiments, the deformable proppant can have a volume ratio of the first polymer component to the second polymer component from 10 percent to 90 percent.

The suspension polymerization that may be employed to form the second polymer component can be maintained at a temperature in a range from 20° C. to 140° C. All individual values and subranges from 20° C. to 140° C. are included herein and disclosed herein; for example, the suspension polymerization that may be employed to form the second polymer component can be maintained at a temperature in a range having a lower limit of 20° C., 23° C., or 25° C. to an upper limit of 140° C., 130° C., or 120° C. For example, the suspension polymerization can be maintained at a temperature in a range from 20° C. to 140° C., 23° C. to 130° C., or 25° C. to 120° C.

The suspension polymerization that may be employed to form the second polymer component can be maintained at a temperature for a time interval in a range of 10 minutes to 24 hours. All individual values and subranges from in a range of 10 minutes to 24 hours are included herein and disclosed herein; for example, the suspension polymerization that may be employed to form the second polymer component can be maintained at a temperature for a time interval a with a lower limit of 10 minutes, 15 minutes, or 30 minutes to an upper limit of 24 hours, 18 hours, or 10 hours. For example, suspension polymerization can be maintained at a temperature for a time interval in a range of 10 minutes to 24 hours, 15 minutes to 18 hours, or 30 minutes to 10 hours. The suspension polymerization that may be employed to form the second polymer component can be maintained at differing temperatures, where each of the differing temperatures is maintained for a particular time interval.

For one or more embodiments, the interpenetrating polymer network may include a gradient of polymer structure along a radius of the deformable proppant. As used herein, “radius” refers to a straight line from a center of mass of the deformable proppant to a point on the deformable proppant that is separated from the center of mass. For example, a radius of the deformable proppant may be considered to be a straight line from a center of mass of the deformable proppant to a point on the deformable proppant that is a greatest distance from the center of mass. The gradient of polymer structure is a change in the polymer structure of the deformable proppant from a center region of the deformable proppant to an outer region of the deformable proppant. The gradient of polymer structure may be abrupt along a radius of the deformable proppant, to provide a deformable proppant having a substantially distinct center region, e.g. a core, and a relatively distinct outer region, e.g. a shell. For embodiments having the gradient of polymer structure the terms center region, core, outer region, and shell are not to be construed as meaning that the deformable proppant will exhibit an distinct interface between the first polymer component and the second polymer component, but rather as an indication of interpenetration of the first polymer component and the second polymer component.

For one or more embodiments, where the interpenetrating polymer network includes the gradient of polymer structure along the radius of the deformable proppant, the deformable proppant is obtainable by forming a first polymer component that includes a crosslinked free-radical matrix. The first polymer component may be formed by a suspension polymerization of a first monoethylenically unsaturated monomer and a first polyethylenically unsaturated monomer. The first polymer component may be contacted by a second monoethylenically unsaturated monomer and a second polyethylenically unsaturated monomer. The second monoethylenically unsaturated monomer and the second polyethylenically unsaturated monomer monomers are constitutional units of a second polymer component. The first polymer component and the second polymer component form the interpenetrating polymer network.

For one or more embodiments, where the interpenetrating polymer network includes the gradient of polymer structure along the radius of the deformable proppant, the first monoethylenically unsaturated monomer and/or the second monoethylenically unsaturated monomer may include the monoethylenically unsaturated monomers, as discussed herein. For one or more embodiments, where the interpenetrating polymer network includes the gradient of polymer structure along the radius of the deformable proppant, the first polyethylenically unsaturated monomer and/or the second polyethylenically unsaturated monomer may include the polyethylenically unsaturated monomers, as discussed herein.

For one or more embodiments, where the interpenetrating polymer network includes the gradient of polymer structure along the radius of the deformable proppant, the first polymer component may be prepared using from 1.0 weight percent to 25.0 weight percent of the first polyethylenically unsaturated monomer, where the weight percents are based upon a total weight of the constitutional units of the first polymer component. All individual values and subranges from 1.0 weight percent to 25.0 weight percent of the first polyethylenically unsaturated monomer are included herein and disclosed herein; for example, the first polymer component may be prepared using from 1.0 weight percent to 15.0 weight percent of the first polyethylenically unsaturated monomer, or 1.0 weight percent to 10.0 weight percent of the first polyethylenically unsaturated monomer weight percent, where the weight percents are based upon a total weight of the constitutional units of the first polymer component.

For one or more embodiments, where the interpenetrating polymer network includes the gradient of polymer structure along the radius of the deformable proppant, the first polymer component may be prepared using from 99.0 weight percent to 75.0 weight percent of the first monoethylenically unsaturated monomer, where the weight percents are based upon a total weight of the constitutional units of the first polymer component. All individual values and subranges from 99.0 weight percent to 75.0 weight percent of the first monoethylenically unsaturated monomer are included herein and disclosed herein; for example, the first polymer component may be prepared using from 99.0 weight percent to 85.0 weight percent of the first monoethylenically unsaturated monomer, or 99.0 weight percent to 90.0 weight percent of the first monoethylenically unsaturated, where the weight percents are based upon a total weight of the constitutional units of the first polymer component.

For one or more embodiments, where the interpenetrating polymer network includes the gradient of polymer structure along the radius of the deformable proppant, the second polymer component may be prepared using from 0.5 weight percent to 10.0 weight percent of the second polyethylenically unsaturated monomer, where the weight percents are based upon a total weight of the constitutional units of the second polymer component. All individual values and subranges from 0.5 weight percent to 10.0 weight percent of the second polyethylenically unsaturated monomer are included herein and disclosed herein; for example, the second polymer component may be prepared using from 0.5 weight percent to 8.0 weight percent of the second polyethylenically unsaturated monomer, or 0.5 weight percent to 5.0 weight percent of the second polyethylenically unsaturated monomer, where the weight percents are based upon a total weight of the constitutional units of the second polymer component.

For one or more embodiments, where the interpenetrating polymer network includes the gradient of polymer structure along the radius of the deformable proppant, the second polymer component may be prepared using from 99.5 weight percent to 90.0 weight percent of the second monoethylenically unsaturated monomer, where the weight percents are based upon a total weight of the constitutional units of the second polymer component. All individual values and subranges from 99.5 weight percent to 90.0 weight percent of the second monoethylenically unsaturated monomer are included herein and disclosed herein; for example, the second polymer component may be prepared using from 99.5 weight percent to 92.0 weight percent of the second monoethylenically unsaturated monomer, 99.5 weight percent to 95.0 weight percent of the second monoethylenically unsaturated monomer, where the weight percents are based upon a total weight of the constitutional units of the second polymer component.

For one or more embodiments, where the interpenetrating polymer network includes the gradient of polymer structure along the radius of the deformable proppant, a volume ratio of the first polymer component to the second polymer component can be from 25 percent to 80 percent. All individual values and subranges from 25 percent to 80 percent are included herein and disclosed herein; for example, a volume ratio of the first polymer component to the second polymer component can be from 25 percent to 80 percent, 30 percent to 75 percent, or 35 percent to 70 percent.

For one or more embodiments, where the interpenetrating polymer network includes the gradient of polymer structure along the radius of the deformable proppant, the suspension polymerization that may be employed to form the first polymer component and/or the second polymer component can include one or more compounds, as discussed herein, other than the first monoethylenically unsaturated monomer, the second monoethylenically unsaturated monomer, the first polyethylenically unsaturated monomer, and/or the second polyethylenically unsaturated monomer. Examples of these compounds include, but are not limited to, suspending agents, polymerization inhibitors, free-radical initiators, surfactants, and combinations thereof. For the suspension polymerization that may be employed to form the first polymer component and/or the second polymer component these compounds may be included based upon a total weight of the first monoethylenically unsaturated monomer, the second monoethylenically unsaturated monomer, the first polyethylenically unsaturated monomer, the second polyethylenically unsaturated monomer, and/or combinations thereof.

For one or more embodiments, where the interpenetrating polymer network includes the gradient of polymer structure along the radius of the deformable proppant, the suspension polymerization that that may be employed to form the first polymer component can be maintained at a temperature in a range from 20° C. to 140° C. All individual values and subranges from 20° C. to 140° C. are included herein and disclosed herein; for example, the suspension polymerization that may be employed to form the first polymer component can be maintained at a temperature in a range having a lower limit of 20° C., 23° C., or 25° C. to an upper limit of 140° C., 130° C., or 120° C. For example, the suspension polymerization can be maintained at a temperature in a range from 20° C. to 140° C., 23° C. to 130° C., or 25° C. to 120° C.

For one or more embodiments, where the interpenetrating polymer network includes the gradient of polymer structure along the radius of the deformable proppant, the suspension polymerization that may be employed to form the first polymer component can be maintained at a temperature for a time interval in a range of 10 minutes to 24 hours. All individual values and subranges from in a range of 10 minutes to 24 hours are included herein and disclosed herein; for example, the suspension polymerization that may be employed to form the first polymer component can be maintained at a temperature for a time interval a with a lower limit of 10 minutes, 15 minutes, or 30 minutes to an upper limit of 24 hours, 18 hours, or 10 hours. For example, suspension polymerization can be maintained at a temperature for a time interval in a range of 10 minutes to 24 hours, 15 minutes to 18 hours, or 30 minutes to 10 hours. The suspension polymerization that may be employed to form the first polymer component can be maintained at differing temperatures, where each of the differing temperatures is maintained for a particular time interval.

The deformable proppants of the present disclosure may have a density in a range from 0.8 g/cm³ to 1.4 g/cm³. All individual values and subranges from 0.8 g/cm³ to 1.4 g/cm³ are included herein and disclosed herein; for example, the deformable proppants of the present disclosure may have a density in a range having a lower limit of 0.8 grams/cubic centimeter (g/cm³), 0.9 g/cm³, or 1.0 g/cm³ to an upper limit of 1.4 g/cm³, 1.3 g/cm³, or 1.2 g/cm³. For example, the deformable proppants may have a density in range from 0.8 g/cm³ to 1.4 g/cm³, 0.9 g/cm³ to 1.3 g/cm³, or 1.0 g/cm³ to 1.2 g/cm³.

The deformable proppants of the present disclosure may be of differing sizes and/or shapes for various applications and/or differing subterranean formations. For one or more embodiments, the deformable proppant is substantially spherical. The deformable proppants of the present disclosure may have a have a size in range from +10 mesh to −140 mesh. All individual values and subranges from +10 mesh to −140 mesh are included herein and disclosed herein; for example, the deformable proppant that is substantially spherical may have a size in range having a lower limit of +10 mesh, +12 mesh, or +14 mesh to an upper limit of −140 mesh, −120 mesh, or −100 mesh, U.S. Standard Sieve Series. For example, the deformable proppant may have a size in a range from +10 mesh to −140 mesh, +12 mesh to −120 mesh, or +14 mesh to −100 mesh, U.S. Standard Sieve Series. For the U.S. Standard Sieve Series, the “+” indicates that no particles will pass through a particular mesh and the “−” indicates that all particles will pass through a particular mesh.

For one or more embodiments, the deformable proppant may be substantially non-spherical. Examples of substantially non-spherical shapes include, but are not limited to, cubic shapes, polygonal shapes, elongate shapes, and combinations thereof. The deformable proppants of the present disclosure that are substantially non-spherical may have a have a volume in a range of 0.001 cubic millimeters (mm³) to 10 mm³. All individual values and subranges from 0.001 cubic mm³ to 10 mm³ mesh are included herein and disclosed herein; for example, the deformable proppant that is substantially non-spherical may have a volume in a range having a lower limit of 0.001 mm³, 0.005 mm³, or 0.01 mm³ to an upper limit of 10 mm³, 8 mm³, or 5 mm³. For example, the deformable proppant that is substantially non-spherical may have a volume in a range of 0.001 mm³ to 10 mm³, 0.005 mm³ to 8 mm³, or 0.01 mm³ to 5 mm³.

### EXAMPLES

In the Examples, various terms and designations for materials were used including, for example, the following:

Water, sodium dichromate (polymerization inhibitor), carboxy methyl methyl cellulose (suspending agent), styrene (monoethylenically unsaturated monomer), divinylbenzene (polyethylenically unsaturated monomer), tert-butyl peroctoate (free radical initiator), sodium lauryl sulfate (surfactant), tert-butyl perbenzoate (free radical initiator), Walocel™ MKX 5000 (suspending agent).

### Example 1

Example 1, a proppant having an interpenetrating polymer network including a first polymer component and a second polymer component, was prepared as follows. Water (933.0 grams); aqueous sodium dichromate solution (2.5 grams, 69 weight percent sodium dichromate); aqueous carboxy methyl methyl cellulose solution (165.0 grams, 1 weight percent carboxy methyl methyl cellulose); and an oil phase including: styrene (1079.0 grams); divinylbenzene solution (10.3 grams, 80 weight percent divinylbenzene); tert-butyl peroctoate solution (6.0 grams, 50 weight percent tert-butyl peroctoate), and tert-butyl perbenzoate (0.53 grams) were added to a 3 liter stainless steel reactor having a loop agitator. Then the reactor was sealed, the reactor headspace was purged with nitrogen and the contents of the reactor were agitated for one hour while being maintained at room temperature (approximately 23° C.). Then, while the contents of the reactor were agitated, the contents of the reactor were heated to 75° C. at a rate of 0.5° C. per minute; the contents of reactor were maintained at 75° C. for 600 minutes. Then, while the contents of the reactor were agitated, the contents of the reactor were heated to 95° C. at a rate of 0.5° C. per minute; the contents of reactor were maintained at 95° C. for 90 minutes. Then, while the contents of the reactor were agitated, the contents of the reactor were heated to 110° C. at a rate of 0.5° C. per minute; the contents of reactor were maintained at 110° C. for 90 minutes. The contents of the reactor were then cooled to room temperature. Thereafter, a product, a first polymer component, was removed from the reactor, washed with water, air dried, and screened.

The washed, air dried, and screened first polymer component (96.0 grams) was added to a 3 liter stainless steel reactor having a loop agitator. Water (573.3 grams), aqueous sodium dichromate solution (0.6 grams, 69 weight percent sodium dichromate), aqueous sodium lauryl sulfate solution (0.4 grams, 30 weight percent sodium lauryl sulfate), styrene (366.2 grams), divinylbenzene solution (31.7 grams, 63 weight percent divinylvenzene), tert-butyl peroctoate solution (10.73 grams, 50 weight percent tert-butyl peroctoate), and tert-butyl perbenzoate (0.75 grams) were added to the reactor. This styrene and divinylbenzene were constitutional units for a second polymer component, which formed an interpenetrating polymer network with the first polymer network. Then the reactor was sealed and the contents of the reactor were agitated for one hour while being maintained at room temperature (approximately 23° C.). The reactor was opened and Walocel™ MKX 5000 solution (257.0 grams, 0.75 weight percent Walocel™ MKX 5000) and sodium lauryl sulfate (0.4 grams) were added to the contents of the reactor. Then the reactor was resealed and the reactor headspace was purged with nitrogen. Then, while the contents of the reactor were agitated, the contents of the reactor were heated to 80° C. at a rate of 0.5° C. per minute; the contents of reactor were maintained at 80° C. for 720 minutes. Then, while the contents of the reactor were agitated, the contents of the reactor were heated to 95° C. at a rate of 0.5° C. per minute; the contents of reactor were maintained at 95° C. for 180 minutes. Then, while the contents of the reactor were agitated, the contents of the reactor were heated to 120° C. at a rate of 0.5° C. per minute; the contents of reactor were maintained at 120° C. for 180 minutes. The contents of the reactor were then cooled to room temperature. Thereafter, Example 1 was removed from the reactor, washed with water, air dried, and screened. Example 1 included approximately 4.2 weight percent of constitutional units derived from divinylbenzene and approximately 95.8 weight percent of constitutional units derived from styrene. Example 1 had a density of 0.8 g/cm³ to 1.4 g/cm³.

### Example 2

Example 2, a proppant having an interpenetrating polymer network including a first polymer component and a second polymer component, was prepared as follows. Water (933.0 grams), aqueous sodium dichromate solution (2.5 grams, 69 weight percent sodium dichromate), aqueous carboxy methyl methyl cellulose solution (165.0 grams, 1 weight percent carboxy methyl methyl cellulose), styrene (960.3 grams), divinylbenzene solution (39.7 grams, 63 weight percent divinylbenzene), tert-butyl peroctoate solution (6.0 grams, 50 weight percent tert-butyl peroctoate), and tert-butyl perbenzoate (0.53 grams) were added to a 3 liter stainless steel reactor having a loop agitator. Then the reactor was sealed, the reactor headspace was purged with nitrogen and the contents of the reactor were agitated for one hour while being maintained at room temperature (approximately 23° C.). Then, while the contents of the reactor were agitated, the contents of the reactor were heated to 75° C. at a rate of 0.5° C. per minute; the contents of reactor were maintained at 75° C. for 600 minutes. Then, while the contents of the reactor were agitated, the contents of the reactor were heated to 95° C. at a rate of 0.5° C. per minute; the contents of reactor were maintained at 95° C. for 90 minutes. Then, while the contents of the reactor were agitated, the contents of the reactor were heated to 110° C. at a rate of 0.5° C. per minute; the contents of reactor were maintained at 110° C. for 90 minutes. The contents of the reactor were then cooled to room temperature. Thereafter, a product, a first polymer component, was removed from the reactor, washed with water, air dried, and screened.

The washed, air dried, and screened first polymer component (230.0 grams) was added to a 3 liter stainless steel reactor having a loop agitator. Water (470.0 grams), aqueous sodium dichromate solution (0.7 grams, 69 weight percent sodium dichromate), aqueous sodium lauryl sulfate solution (0.2 grams, 30 weight percent sodium lauryl sulfate), styrene (172.0 grams), divinylbenzene solution (24.0 grams, 63 weight percent divinylvenzene), tert-butyl peroctoate solution (0.4 grams, 50 weight percent tert-butyl peroctoate), and tert-butyl perbenzoate (0.2 grams) were added to the reactor. This styrene and divinylbenzene were constitutional units for a portion of the second polymer component, which formed an interpenetrating polymer network with the first polymer network. Then the reactor was sealed and the contents of the reactor were agitated for one hour while being maintained at room temperature (approximately 23° C.). The reactor was opened and Walocel™ MKX 5000 solution (116.0 grams, 0.75 weight percent Walocel™ MKX 5000) and sodium lauryl sulfate (0.2 grams) were added to the contents of the reactor. Then the reactor was resealed and the reactor headspace was purged with nitrogen. Then, while the contents of the reactor were agitated, the contents of the reactor were heated to 80° C. at a rate of 0.5° C. per minute. The contents of reactor were maintained at 80° C. for 420 minutes; sixty minutes after the contents of the reactor reached 80° C. styrene (321.0 grams) and divinylbenzene solution (34.0 grams, 63 weight percent divinylvenzene) were added to the contents of the reactor over 120 minutes. This styrene and divinylbenzene were constitutional units for a portion of the second polymer component, which formed an interpenetrating polymer network with the first polymer network. Then the contents of the reactor were heated to 110° C. at a rate of 0.5° C. per minute; the contents of reactor were maintained at 110° C. for 120 minutes. Thereafter, Example 2 was removed from the reactor, washed with water, air dried, and screened. Example 2 included approximately 5.4 weight percent of constitutional units derived from divinylbenzene and approximately 94.6 weight percent of constitutional units derived from styrene. Example 2 had a density of 0.8 g/cm³ to 1.4 g/cm³.

### Example 3

Example 3, a proppant having an interpenetrating polymer network including a first polymer component and a second polymer component, was prepared as follows. Water (900.0 grams), aqueous sodium dichromate solution (1.5 grams, 69 weight percent sodium dichormate), aqueous carboxy methyl methyl cellulose solution (100.0 grams, 1 weight percent carboxy methyl methyl cellulose), styrene (322.25 grams), divinylbenzene solution (27.78 grams, 63 weight percent divinylbenzene), tert-butyl peroctoate solution (1.0 grams, 50 weight percent tert-butyl peroctoate), and tert-butyl perbenzoate (0.5 grams) were added to a 3 liter stainless steel reactor having a loop agitator. This styrene and divinylbenzene were constitutional units for a first polymer component. Then the reactor was sealed and the contents of the reactor were agitated for one hour while being maintained at room temperature (approximately 23° C.). Then, while the contents of the reactor were agitated, the contents of the reactor were heated to 80° C. at a rate of 0.5° C. per minute; the contents of reactor were maintained at 80° C. for 265 minutes. Eighty-five minutes after the contents of the reactor reached 80° C. 300 grams of a mixture including styrene (705 grams) and divinylbenzene solution (5.64 grams, 63 weight percent divinylbenzene) was added to the contents of the reactor over 120 minutes. This styrene and divinylbenzene were constitutional units for a second polymer component. Then, while the contents of the reactor were agitated, the contents of the reactor were heated to 95° C. at a rate of 0.5° C. per minute; the contents of reactor were maintained at 95° C. for 90 minutes. Thereafter, the contents of the reactor were heated to 110° C. at a rate of 0.5° C. per minute; the contents of reactor were maintained at 110° C. for 90 minutes. The contents of the reactor were then cooled to room temperature. Thereafter, Example 3 was removed from the reactor, washed air dried, and screened. Example 3 included approximately 2.0 weight percent of constitutional units derived from divinylbenzene and approximately 98.0 weight percent of constitutional units derived from styrene. Example 3 had a density of 0.8 g/cm³ to 1.4 g/cm³.

### Comparative Examples A-C

Comparative Example A, a styrene/divinylbenzene copolymer having approximately 4 weight percent of constitutional units derived from divinylbenzene and approximately 96 weight percent of constitutional units derived from styrene, was prepared as follows. Water (985.0 grams), aqueous sodium dichromate solution (2.5 grams, 69 weight percent sodium dichromate), aqueous carboxy methyl methyl cellulose solution (313.0 grams, 1 weight percent carboxy methyl methyl cellulose), styrene (730.0 grams), divinylbenzene solution (50.0 grams, 63 weight percent divinylbenzene), tert-butyl peroctoate solution (0.33 grams, 50 weight percent tert-butyl peroctoate), and tert-butyl perbenzoate (1.31 grams) were added to a 3 liter stainless steel reactor having a loop agitator. Then the reactor was sealed and the reactor headspace was purged with nitrogen. Then the reactor was sealed the contents of the reactor were agitated for one hour while being maintained at room temperature (approximately 23° C.). Then, while the contents of the reactor were agitated, the contents of the reactor were heated to 80° C. at a rate of 0.5° C. per minute; the contents of reactor were maintained at 80° C. for 480 minutes. Then, while the contents of the reactor were agitated, the contents of the reactor were heated to 95° C. at a rate of 0.5° C. per minute; the contents of reactor were maintained at 95° C. for 180 minutes. The contents of the reactor were then cooled to room temperature. Thereafter, Comparative Example A was removed from the reactor, washed, air dried, and screened.

Comparative Example B, a styrene/divinylbenzene copolymer having approximately 6 weight percent of constitutional units derived from divinylbenzene and approximately 94 weight percent of constitutional units derived from styrene, was prepared as Comparative Example A with the change: divinylbenzene solution (76.8 grams, 63 weight percent divinylbenzene) was employed.

Comparative Example C, a styrene/divinylbenzene copolymer having approximately 10 weight percent of constitutional units derived from divinylbenzene and approximately 90 weight percent of constitutional units derived from styrene, was prepared as Comparative Example A with the change: divinylbenzene solution (137.7 grams, 63 weight percent divinylbenzene) was employed. Comparative Examples A-C had a density of 0.8 g/cm³ to 1.4 g/cm³.

Particle size distribution for Examples 1-2 was determined. The results, including the average particle size, are shown in Table I.

TABLE I

| | U.S. Standard Sieve Series | | | | | | | |
|---|---|---|---|---|---|---|---|---|
| | | −20 | −25 | −30 | −35 | −40 | | Average |
| | | mesh/ | mesh/ | mesh/ | mesh/ | mesh/ | | Particle |
| | −20 | +25 | +30 | +35 | +40 | +50 | −50 | Size |
| Example # | mesh | mesh | mesh | mesh | mesh | mesh | mesh | (millimeter) |
| Example 1 | 0.0 | 0.0 | 2.0 | 23.5 | 74.4 | 0.1 | 0.0 | 0.487 |
| | (weight | (weight | (weight | (weight | (weight | (weight | (weight | |
| | percent) | percent) | percent) | percent) | percent) | percent) | percent) | |
| Example 2 | 0.0 | 3.3 | 27.6 | 33.9 | 22.7 | 12.5 | 0.1 | 0.550 |
| | (weight | (weight | (weight | (weight | (weight | (weight | (weight | |
| | percent) | percent) | percent) | percent) | percent) | percent) | percent) | |

Particle size distribution for Comparative Examples A-C was determined. The results of this testing, including the average particle size, are shown in Table II.

TABLE II

| | U.S. Standard Sieve Series | | | | | | | |
|---|---|---|---|---|---|---|---|---|
| | | −20 | −25 | −30 | −35 | −40 | | Average |
| | | mesh/ | mesh/ | mesh/ | mesh/ | mesh/ | | Particle |
| Comparative | −20 | +25 | +30 | +35 | +40 | +50 | −50 | Size |
| Example # | mesh | mesh | mesh | mesh | mesh | mesh | mesh | (millimeter) |
| Comparative | 1.5 | 30.9 | 42.2 | 18.6 | 5.8 | 0.8 | 0.1 | 0.665 |
| Example A | (weight | (weight | (weight | (weight | (weight | (weight | (weight | |
| | percent) | percent) | percent) | percent) | percent) | percent) | percent) | |
| Comparative | 0.0 | 12.2 | 40.3 | 33.6 | 13.7 | 0.2 | 0.10 | 0.608 |
| Example B | (weight | (weight | (weight | (weight | (weight | (weight | (weight | |
| | percent) | percent) | percent) | percent) | percent) | percent) | percent) | |
| Comparative | 0.0 | 11.6 | 44.0 | 30.2 | 13.3 | 0.9 | 0.0 | 0.610 |
| Example C | (weight | (weight | (weight | (weight | (weight | (weight | (weight | |
| | percent) | percent) | percent) | percent) | percent) | percent) | percent) | |

A comparative evaluation for gap width of Examples 1-3, where the proppants had a diameter of approximately 0.54 millimeters, and Comparative Examples A-C, where the copolymers had a diameter of approximately 0.54 millimeters, was performed utilizing an Instron® load frame and 2 anvils, each covered with a sandstone wafer (Scioto formation sandstone, 0.9 cm thick), and heated to 220° F. (104° C.). The results are shown in Table III and Table IV, respectively.

TABLE III

| | Gap width at | Gap width at | Gap width at | Gap width at | Gap width at | Gap width at |
|---|---|---|---|---|---|---|
| | −1 kilogram- | −2 kilogram- | −3 kilogram- | −4 kilogram- | −5 kilogram- | −6 kilogram- |
| Example # | force | force | force | force | force | force |
| Example 1 | 0.218 mm | 0.169 mm | 0.145 mm | 0.131 mm | 0.119 mm | 0.110 mm |
| Example 2 | 0.283 mm | 0.219 mm | 0.190 mm | 0.170 mm | 0.156 mm | 0.144 mm |
| Example 3 | 0.253 mm | 0.193 mm | 0.163 mm | 0.143 mm | 0.127 mm | 0.115 mm |

TABLE IV

| | Gap width at | Gap width at | Gap width at | Gap width at | Gap width at | Gap width at |
|---|---|---|---|---|---|---|
| Comparative | −1 kilogram- | −2 kilogram- | −3 kilogram- | −4 kilogram- | −5 kilogram- | −6 kilogram- |
| Example # | force | force | force | force | force | force |
| Comparative | 0.209 mm | 0.162 mm | 0.145 mm | 0.126 mm | 0.115 mm | 0.106 mm |
| Example A | | | | | | |
| Comparative | 0.215 mm | 0.172 mm | 0.151 mm | 0.136 mm | 0.125 mm | 0.116 mm |
| Example B | | | | | | |
| Comparative | 0.245 mm | 0.195 mm | 0.173 mm | 0.158 mm | 0.146 mm | 0.137 mm |
| Example C | | | | | | |

The data in Table III and Table IV shows Examples 1-2 provide a gap width under pressure that is greater than or comparable to a gap width provided by Comparative Examples A-C, which do not include the interpenetrating polymer network. Example 3 provides a gap width under pressure that is greater than or comparable to a gap width provided by Comparative Examples A-B.

The data in Table III and Table IV shows that Example 1 provides a gap width under pressure that is greater than a gap width provided by Comparative Example A for each pressure tested. This greater gap width is achieved while incorporating a lower percentage of divinylbenzene.

Likewise, the data in Table III and Table IV shows that Example 2 provides a gap width under pressure that is greater than a gap width provided by Comparative Examples B-C for each pressure tested. This greater gap width is achieved while incorporating a lower percentage of divinylbenzene.

Further, the data in Table III and Table IV shows that Example 3 provides a gap width under pressure that is greater or comparable than a gap width provided by Comparative Examples A-B for each pressure tested. This greater gap width is achieved while incorporating a lower percentage of divinylbenzene.

Conductivity for Examples 1-2, having the particle size distributions described in Table II, was determined by ISO 13503-5 with the change: 0.02 pounds per square foot of a respective Example was spread homogeneously on the load cell to provide a simulation of a partial proppant monolayer on a surface of a subterranean formation. The results of this testing for various pressures (pounds per square inch (psi)) are shown in Table V.

TABLE V

| | Conductivity | | | |
|---|---|---|---|---|
| | (millidarcy-feet) | | | |
| Example # | at 1000 psi | at 3000 psi | at 5000 psi | at 6000 psi |
| Example 1 | 1090.0 | 320.0 | 128.0 | 105.0 |
| Example 2 | 414.0 | 125.0 | 59.5 | 37.7 |

Conductivity for Comparative Examples A-C, having the particle size distributions described in Table III, was determined as for Examples 1-2 with the change: Comparative Examples A-C replaced Examples 1-2. The results of this testing are shown in Table VI.

TABLE VI

| | Conductivity | | | |
|---|---|---|---|---|
| Comparative | (millidarcy-feet) | | | |
| Example # | at 1000 psi | at 3000 psi | at 5000 psi | at 6000 psi |
| Comparative | 386.0 | 132.0 | 64.3 | 45.1 |
| Example A | | | | |
| Comparative | 361.0 | 127.0 | 47.1 | 19.8 |
| Example B | | | | |
| Comparative | 945.0 | 300.0 | 142.0 | 72.6 |
| Example C | | | | |

The data in Table V and Table VI shows that for a number of pressures tested Example 1 provides a greater conductivity than each of Comparative Example A, Comparative Example B, and Comparative Example C. Additionally, the data in Table V and Table VI shows that for a number of pressures tested Example 2 provides a greater or comparable conductivity than each of Comparative Example A and Comparative Example B. The greater and/or comparable conductivities provided by Examples 1-2, as compared to Comparative Examples A-C, were surprising, in part, because both of Examples 1-2 had a lesser average particle size than each of Comparative Examples A-C.

Additionally, data in Table V shows that Examples 1-2 can provide a conductivity of at least 100 millidarcy-feet at 220 degrees Fahrenheit and at lower temperatures where conductivities are greater due to reduced temperature induced softening of the proppant.

1. A method for treating a subterranean formation comprising:
injecting into the subterranean formation a fluid composition that includes a fluid and a deformable proppant having an interpenetrating polymer network formed from a first polymer component and a second polymer component and a density at 23° C. of 0.8 g/cm³ to 1.14 g/cm³.

2. The method of claim 1, wherein the first polymer component includes constitutional units derived from a first monoethylenically unsaturated monomer at a weight percent of 99.9 weight percent to 90.0 weight percent of the first polymer component and constitutional units derived from a first polyethylenically unsaturated monomer at a weight percent of 0.1 weight percent to 10.0 weight percent of the first polymer component and the second polymer component includes constitutional units derived from a second monoethylenically unsaturated monomer at a weight percent of 99.5 weight percent to 80.0 weight percent of the second polymer component and constitutional units derived from a second polyethylenically unsaturated monomer at a weight percent of 0.5 weight percent to 20.0 weigh percent of the second polymer component.

3. The method of claim 2, wherein the constitutional units derived from the first monoethylenically unsaturated monomer are 99.9 weight percent to 92.0 weight percent of the first polymer component and constitutional units derived from a first polyethylenically unsaturated monomer at a weight percent of 0.1 weight percent to 8.0 weight percent of the first polymer component and the second polymer component includes constitutional units derived from a second monoethylenically unsaturated monomer at a weight percent of 99.5 weight percent to 85.0 weight percent of the second polymer component and constitutional units derived from a second polyethylenically unsaturated monomer at a weight percent of 0.5 weight percent to 15.0 weigh percent of the second polymer component.

4. The method of claim 1, wherein the first polymer component includes constitutional units derived from a first monoethylenically unsaturated monomer at a weight percent of 99.0 weight percent to 75.0 weight percent of the first polymer component and constitutional units derived from a first polyethylenically unsaturated monomer at a weight percent of 1.0 weight percent to 25.0 weight percent of the first polymer component and the second polymer component includes constitutional units derived from a second monoethylenically unsaturated monomer at a weight percent of 99.5 weight percent to 90.0 weight percent of the second polymer component and constitutional units derived from a second polyethylenically unsaturated monomer at a weight percent of 0.5 weight percent to 10.0 weight percent of the second polymer component.

5. The method of claim 4, wherein the constitutional units derived from the first monoethylenically unsaturated monomer are 99.0 weight percent to 85.0 weight percent of the first polymer component and constitutional units derived from a first polyethylenically unsaturated monomer at a weight percent of 1.0 weight percent to 15.0 weight percent of the first polymer component and the second polymer component includes constitutional units derived from a second monoethylenically unsaturated monomer at a weight percent of 99.5 weight percent to 92.0 weight percent of the second polymer component and constitutional units derived from a second polyethylenically unsaturated monomer at a weight percent of 0.5 weight percent to 8.0 weigh percent of the second polymer component.

6. The method of claim 1, wherein the first monoethylenically unsaturated monomer and the second monoethylenically unsaturated monomer are monovinylidiene aromatics, and the first polyethylenically unsaturated monomer and the second polyethylenically unsaturated monomer are polydivinylidene aromatics.

7. The method of claim 1, wherein the first monoethylenically unsaturated monomer and the second monoethylenically unsaturated monomer are styrene and the first polyethylenically unsaturated monomer and the second polyethylenically unsaturated monomer are divinylbenzene.

8. The method of claim 1, wherein the deformable proppant is substantially spherical and has a size of 10 mesh to 140 mesh U.S. Standard Sieve Series.

9. The method of claim 1, wherein the deformable proppant has a volume ratio of the first polymer component to the second polymer component from 10 percent to 90 percent.

10. The method of claim 1, wherein the deformable proppant provides a conductivity in the subterranean formation of at least 100 millidarcy-feet at 38 degrees Celsius.

11. The method of claim 1, wherein the fluid is selected from the group of water-based fluids, hydrocarbon-based fluids, foams, gas-based fluids or a combination thereof.

12. The method of claim 1, including employing the deformable proppant at a concentration that creates a partial proppant monolayer on a surface of the subterranean formation.

13. A deformable proppant useful for treatment of a subterranean formation obtainable by a process comprising:
forming first polymer component from a first monoethylenically unsaturated monomer and a first polyethylenically unsaturated monomer;
forming a suspension of the first polymer component in a continuous aqueous phase, wherein the first polymer component is particulate; and
forming a second polymer component from a second monoethylenically unsaturated monomer and a second polyethylenically unsaturated monomer, wherein the first polymer component and the second polymer component form an interpenetrating polymer network to provide the deformable proppant with a density at 23° C. of 0.8 g/cm³ to 1.14 g/cm³.

14. The proppant of claim 13, wherein the first polymer component includes constitutional units derived from the first monoethylenically unsaturated monomer at a weight percent of 99.9 weight percent to 90.0 weight percent of the first polymer component and constitutional units derived from the first polyethylenically unsaturated monomer at a weight percent of 0.1 weight percent to 10.0 weight percent of the first polymer component and the second polymer component includes constitutional units derived from the second monoethylenically unsaturated monomer at a weight percent of 99.5 weight percent to 80.0 weight percent of the second polymer component and constitutional units derived from the second polyethylenically unsaturated monomer at a weight percent of 0.5 weight percent to 20.0 weigh percent of the second polymer component.

15. The proppant of claim 13, wherein the first polymer component includes constitutional units derived from the first monoethylenically unsaturated monomer at a weight percent of 95.0 weight percent to 75.0 weight percent of the first polymer component and constitutional units derived from a first polyethylenically unsaturated monomer at a weight percent of 5.0 weight percent to 25.0 weight percent of the first polymer component and the second polymer component includes constitutional units derived from a second monoethylenically unsaturated monomer at a weight percent of 99.5 weight percent to 90.0 weight percent of the second polymer component and constitutional units derived from a second polyethylenically unsaturated monomer at a weight percent of 0.5 weight percent to 10.0 weigh percent of the second polymer component.

16. The proppant of claim 13, wherein the first monoethylenically unsaturated monomer and the second monoethylenically unsaturated monomer are monovinylidiene aromatics, and the first polyethylenically unsaturated monomer and the second polyethylenically unsaturated monomer are polydivinylidene aromatics.

17. The method of claim 13, wherein the first monoethylenically unsaturated monomer and the second monoethylenically unsaturated monomer are styrene and the first polyethylenically unsaturated monomer and the second polyethylenically unsaturated monomer are divinylbenzene.
